(19) United States
(12) Patent Application Publication
(10) Pub. No.: US 2005/0163885 A1
(43) Pub. Date: Jul. 28, 2005

(54) Dough improver

(76) Inventor: Robert Rees, Somerset (GB)

Correspondence Address: CLARK & BRODY, 1090 VERMONT AVENUE, NW, SUITE 250, WASHINGTON, DC, 20005, US

(21) Appl. No.: 11/038,136

(22) Filed: Jan. 21, 2005

(30) Foreign Application Priority Data
Jan. 28, 2004 (GB) 0401843.8

(51) Int. Cl. A21D 2/00

(52) U.S. Cl. 426/19

(57) ABSTRACT

A method of manufacturing a dough improver, the method comprises the steps of, (a) mixing flour, water and a source of fermentation enzymes; (b) allowing the mixture to ferment; (c) co-mixing further flour and water with the fermented mixture; and (d) allowing the co-mixture to ferment.

This invention relates to a method of manufacturing dough improvers and a method of manufacturing dough, especially for the baking of bread, with the addition of such dough improvers.

It is known to use dough improvers, especially bread improvers in the manufacture of dough and bread in domestic and commercial baking. The improvers generally consist of enzymes, additives or synthetic chemicals, generally in a dry form. In addition, pre-fermented dough can be added to produce a particular type of dough named sourdough. The improvers are added to a dough mixture before baking in an oven to produce bread or other bakery items.

The addition of improvers reduces or eliminates the time needed for fermentation of the dough mixture by speeding up the action of the yeast contained therein.

The use of dough improvers, however, raises health questions as the addition of such chemicals may cause adverse effects to the consumer. In addition the consumer is unaware, without explicit labelling of products, of the types of additive and chemicals that have been used to produce the products and, therefore, is unable to make an informed choice when purchasing such items. It is advantageous and desirable therefore to produce bakery items without the need for the addition of such potentially harmful improvers.

It is therefore an object of the present invention to provide dough improvers which reduce the fermentation time of a dough mixture without the need to add undesirable chemical additives.

According to a first aspect of the present invention there is provided a method of manufacturing a dough improver, the method comprising the steps of:
(a) mixing flour, water and a source of fermentation enzymes;
(b) allowing the mixture to ferment;
(c) co-mixing further flour and water with the fermented mixture; and
(d) allowing the co-mixture to ferment.

The ratio of flour to water in step (a) is required to be suitable for the drying process and is preferably 2:1.

The mixing process may take place using a spiral mixer, preferably at a low speed.

Additionally, the method may further comprise a step (e) of drying the fermented co-mixture produced from step (d). The drying step may be carried out in a cabinet drier such as a Mitchell dryer or a ring, drum, roller or spray dryer; a vacuum oven or a freeze drier and is effected by a method selected from: drying the fermented co-mixture in air at elevated temperatures; microwave drying; dual electric drying (blown air and heat), and freeze drying. Preferably, step (e) is performed at a temperature of below 55° C. and until the fermented co-mixture produced in step (d) forms a substantially moisture free solid dough improver. The dough improver may then be milled or ground into the form of a powder or granules of a flour consistency, preferably using a hammer mill.

The method may comprise a step (f) of packaging the product of step (e) in a suitable container. Preferably step (f) comprises packing the product of step (e) in a container, substantially removing air from the container and sealing the container. The air may be removed by application of a vacuum to the interior of the container before and during the sealing step. Before sealing the container an inert gas, such as nitrogen for example, may be introduced into the container. Suitable containers are bags, boxes, sachets, vacuum packs and the like, and are preferably constructed from plastics material.

According to a second aspect of the invention there is provided a dough improver obtainable by the method of the first aspect of the invention.

According to a third aspect of the present invention there is provided a method of manufacturing a dough mixture, the method comprising:
(i) mixing flour, salt, yeast and water; and
(ii) adding to the product of step (i) a dough improver according to the second aspect of the invention.

The method may also include a proving step in which the dough is allowed to rest before moulding following step (ii). The proving step is preferably carried out over a period of up to 18 minutes, more preferably up to 6 minutes.

Preferably the dough mixture is maintained at a temperature of 30.5±1° C. Preferably, the dough improver is dried.

The amount of dough improver, calculated as dried dough improver, added in step (ii) is preferably up to 15%, more preferably 4-8%.

According to a fourth aspect of the present invention there is provided a dough mixture obtainable by the method of the third aspect of the invention.

According to a fifth aspect the present invention provides for the use of the dough improver according to the second aspect of the invention in the manufacture of dough.

According to a sixth aspect the present invention provides for the use of dough according to the fifth aspect of the invention in the manufacture of bakery items.

The source of fermentation enzymes is preferably a refined yeast, such as that which is commercially available as baker's yeast.

Where the source of fermentation is a refined yeast, salt is preferably added in step (a). The ratio by weight of flour, salt, yeast and water mixed in step (a) may be between 150 and 180 to between 0.5 and 1.5 to between 2 and 6, to between 80 and 90, respectively; and is preferably 160:1:4:84 respectively. Preferably, the mixture is allowed to ferment for approximately 18 to approximately 24 hours and at a temperature of approximately 21° C. in each of steps (b) and (d).

Where the source of fermentation is a refined yeast, step (a) or step (i) may further include mixing gluten with the flour, salt, yeast and water. The ratio of flour, salt, yeast, water and gluten mixed in step (a) or step (i) may be between 150 and 180 to between 0.5 and 1.5, to between 2 and 6 to between 80 and 90 to between 1 and 3 respectively. Preferably the ratio of flour, salt and yeast, water and gluten mixed in step (a) is substantially 160:1:4:84:2.

Alternatively or additionally, the source of fermentation enzymes may be a quntity of grapes or grape skins. The grapes or skins are preferably added contained in a porous material to allow the natural yeast to be transferred to the mixture. The material is preferably a cloth material, more preferably a muslin cloth.

Where the source of fermentation enzymes is a quantity of grapes or skins, the mixture is preferably allowed to ferment in step (b) for approximately 3 days and at a temperature of approximately 17 to 32° C., more preferably 21 to 22° C. The mixture of step (c) is preferably allowed to ferment for approximately 6 days and at a temperature of approximately 17 to 32° C., more preferably 25° C.

Where the source of fermentation enzymes is a quantity of grapes or skins, the method may comprise a further step (g) which comprises taking a small amount of the co-mixture produced from step (d) and adding to it further flour and water. Additionally, the method may further comprise a step (h) which comprises adding further flour and water to the mixture produced in step (g). Step (h) may be carried out more than once and is preferably carried out at intervals of approximately 5 hours. The mixture produced from steps (d), (g) or (h) may be allowed to further ferment, preferably for a period up to 15 hours. Step (h) may be carried out daily for up to 4 days.

The method of the invention produces a dough improver which does not need chemical improvers added during manufacture, and thus is environmentally beneficial and cheaper to manufacture than doughs in which chemical improvers are incorporated, and which removes any health risks to an end user from ingesting chemical improvers. The method also produces a dough improver which when blended with dough and baked in a conventional fashion produces products full of flavour and very palatable to the end user.

Preferred embodiments of the invention will now be described in more detail by way of example only.

The following materials were used:
Flour—strong white flour, manufactured by any miller.
Water—tap water, UK.
Salt—manufactured by any salt manufacturer.
Yeast—baker's yeast manufactured by Rank Hovis, UK.
Gluten—supplied by any supplier.

### EXAMPLE 1

A dough improver was prepared by the following two-stage fermentaion process:

The following ingredients were mixed in a large bowl.

| Ingredients | Amount |
|---|---|
| Flour | 4.536 kg (10 lbs) |
| Salt | 28.35 g (1 oz) |
| Gluten | 56.70 g (2 oz) |
| Yeast | 113.40 g (4 oz) |
| Water | 2.381 kg (5 lbs 4 oz) |

After the ingredients had been mixed, they were left to ferment for 24 hours.

At the end of the 24 hour fermentation period the following ingredients were added to the fermented mixture:

| Ingredients | Amount |
|---|---|
| Flour | 4.536 kg (10 lbs) |
| Salt | 28.35 g (1 oz) |
| Water | 2.381 kg (5 lbs 4 oz) |

The co-mixture was allowed to ferment for another 24 hours with no yeast or gluten added.

At the end of the second fermentation stage the fermented co-mixture was immediately blended with a desired bread dough for subsequent baking.

The bread dough plus improver was then baked, in a conventional manner, to produce loaves of bread having full flavour, consistency and an attractive appearance.

1The entire method was performed without the use of chemical agents thereby reducing potential health risks and environmental concerns, while still giving a bread product having all the advantages of having an added improver.

### EXAMPLE 2

The method of Example 1 was repeated, with the additional step of freeze-drying the fermented co-mixture produced after the second fermentation step. The freeze-drying took 4 hours, and the second fermentation step was adjusted accordingly to 20 hours such that the total period of the second fermentation step and the freeze drying step did not exceed 24 hours. By careful experimentation, it has been found that the second fermentation step plus drying step combined should preferably take no longer than 24 hours, in order to achieve the most advantageous results in conferring beneficial characteristics to the dough improver.

The freeze-dried dough improver was then vacuum-sealed in a suitable plastic bag, and stored at ambient temperatures until needed.

In other embodiments, the freeze-drying step may be replaced by microwave drying or hot air drying, or any other suitable drying which removes moisture from the dough improver. Instead of vacuum-sealing any packaging, an inert gas such as nitrogen may be introduced into the packaging in order to create anaerobic conditions within the packaging so that the dough improver does not spoil on storage.

### EXAMPLE 3

A dough improver was prepared by the following process:

The following ingredients were mixed.

| Ingredients | Amount |
|---|---|
| Flour | 0.454 kg (1 lbs) |
| Water | 0.907 kg (2 lb) |
| Grapes | 0.454 kg (1 lbs) |

After the ingredients had been mixed, they were left to ferment for 72 hours at a temperature of 22.2° C.

At the end of the 72 hour fermentation period the following ingredients were added to the fermented mixture:

| Ingredients | Amount |
|---|---|
| Flour | 0.113 kg (4 oz) |
| Water | 0.227 kg (8 oz) |

The water added was at a temperature of 25.6° C.

The co-mixture was allowed to ferment for another 144 hours.

At the end of the second fermentation stage 0.51 kg (1 lb 2 oz) of the fermented co-mixture was blended with 0.227 kg (8 oz) of water at 25.6 and 0.156 kg (5.5 oz) of flour. After a period of 5 hours, a further 0.454 kg (1 lb) of water and 0.312 kg (11 oz) of flour were added. Following a further period of 5 hours, 0.907 kg 2 lb of water at a temperature of 25.6° C. and 0.624 kg (1 lb 6 oz) of flour were added.

The mixture was allowed to ferment for 15 hours.

The addition of flour and water was repeated daily for 4 days and the final mixture was dried.

All of the features disclosed in this specification and/or all of the steps of any method or process so disclosed may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification or to any novel one, or any novel combination, of the steps of any method or process so disclosed.

1. A method of manufacturing a dough improver, the method comprising the steps of;
(a) mixing flour, water and a source of fermentation enzymes;
(b) allowing the mixture to ferment;
(c) co-mixing further flour and water with the fermented mixture; and
(d) allowing the co-mixture to ferment.

2. A method according to claim 1, in which the ratio of flour to water in step (a) is 2:1.

3. A method according to claim 1, in which a spiral mixer is used in the mixing steps at low speed.

4. A method according to claim 1 further comprising a step (e) of drying the fermented co-mixture produced from step (d).

5. A method according to claim 4, in which step (e) is carried out in a cabinet drier, a vacuum oven or a freeze drier

6. A method according to claim 5, in which the cabinet drier is a Mitchell dryer or a ring, drum, roller or spray dryer.

7. A method according to claim 4, in which step (e) is effected by a method selected from: drying the fermented co-mixture in air at elevated temperatures; microwave drying and dual electric drying (blown air and heat).

8. A method according to claim 4, in which step (e) is performed at a temperature of below 55° C.

9. A method according to claim 4, in which the dough improver is milled or ground into the form of a powder or granules of a flour consistency.

10. A method according to claim 9, in which the milling is performed using a hammer mill.

11. A method according to claim 4 further comprising a step (f) of packing the dough improver in a container, removing air from the container and sealing the container.

12. A method according to claim 11, in which an inert gas is introduced into the container before sealing.

13. A method according to claim 1, in which the source of fermentation enzymes is a refined yeast.

14. A method according to claim 13, in which salt is additionally added in step (a).

15. A method according to claim 14, in which the ratio by weight of flour, salt, yeast and water mixed in step (a) is between 150 and 180 to between 0.5 and 1.5 to between 2 and 6, to between 80 and 90, respectively.

16. (canceled)

17. A method according to claim 13, in which the mixture is allowed to ferment for approximately 18 to approximately 24 hours.

18. A method according to claim 13, in which the mixture is fermented at a temperature of approximately 21° C. in each of steps (b) and (d).

19. A method according to claim 13, in which step (a) further includes mixing gluten with the flour, salt, yeast and water.

20. A method according to claim 19, in which the ratio of flour, salt, yeast, water and gluten mixed in step (a) is between 150 and 180 to between 0.5 and 1.5, to between 2 and 6 to between 80 and 90 to between 1 and 3 respectively.

21. (canceled)

22. A method according to claim 1, in which the source of fermentation enzymes is a quantity of grapes or grape skins.

23. A method according to claim 22, in which the grapes or skins are added contained in a porous material.

24. A method according to claim 23, in which the material is a cloth material such as muslin.

25. (canceled)

26. A method according to claim 22, in which the mixture is allowed to ferment in step (b) for approximately 3 days and/or ferment at a temperature of approximately 17 to 32° C.

27. (canceled)

28. (canceled)

29. A method according to claim 22, in which the co-mixture is allowed to ferment in step (d) for approximately 6 days and/or allowed to ferment in step (d) at a temperature of approximately 17 to 32° C.

30. (canceled)

31. (canceled)

32. A method according to claim 23 further comprising step (g) which comprises taking a small amount of the co-mixture produced from step (d) and adding to it further flour and water.

33. A method according to claim 32 further comprising a step (h) which comprises adding further flour and water to the mixture produced in step (g).

34. A method according to claim 33, in which step (h) is carried out more than once.

35. A method according to claim 34, in which multiple steps (h) are carried out at intervals of approximately 5 hours.

36. A method according to claim 22, in which the mixture produced from steps (d), (g) or (h) is allowed to further ferment.

37. A method according to claim 36, in which the mixture is allowed to ferment for a period up to 15 hours.

38. A method according to claim 33 in which a set of multiple steps (h) is carried out daily.

39. A method according to claim 38, in which the set is carried out daily for up to 4 days.

40. A dough improver made by the method of claim 1.

41. A method of manufacturing a dough mixture, the method comprising:
(i) mixing flour, salt, yeast and water; and
(ii) adding to the product of step (i) a dough improver made by the method of claim 1.

42. A method according to claim 41 further comprising a proving step in which the dough is allowed to rest before moulding following step (ii).

43. A method according to claim 42, in which the proving step is carried out over a period of up to 18 minutes.

44. A method according to claim 43, in which the proving step is carried out over a period of up to 6 minutes.

45. A method according to claim 41, in which the dough mixture is maintained at a temperature of 30.5±1° C.

46. A method according to claim 41, in which the amount of dough improver, calculated as dried dough improver, added in step (ii) is up to 15%.

47. A method according to claim 46, in which the amount of dough improver, calculated as dried dough improver, added in step (ii) is 4-8%.

48. A method according to claim 41 further comprising the addition of gluten in step (i).

49. A dough mixture made by the method of claim 41.

50. (canceled)

51. (canceled)
